(19) United States
(12) Patent Application Publication
(10) Pub. No.: US 2021/0176051 A1
(43) Pub. Date: Jun. 10, 2021

(54) METHOD, DEVICES AND COMPUTER PROGRAM PRODUCT FOR EXAMINING CONNECTION PARAMETERS OF A CRYPTOGRAPHICALLY PROTECTED COMMUNICATION CONNECTION DURING ESTABLISHING OF THE CONNECTION

(71) Applicant: Siemens Mobility GmbH, München (DE)

(72) Inventors: Rainer Falk, Poing (DE); Steffen Fries, Baldham (DE)

(21) Appl. No.: 16/632,072

(22) PCT Filed: Jun. 7, 2018
(86) PCT No.: PCT/EP2018/065020

§ 371 Date: Jan. 17, 2020

(30) Foreign Application Priority Data
Jul. 20, 2017 (DE) 10 2017 212 474.1

(51) Int. Cl. H04L 9/08; H04L 29/08

(52) U.S. Cl. CPC H04L 9/0827; H04L 67/141; H04L 2209/26; H04L 9/0844; H04L 9/088

(57) ABSTRACT

A method for examining connection parameters during establishing of a cryptographically protected communication connection between a first communication device and a second communication device, comprising the method steps: transmitting an attestation data structure, which contains at least one connection parameter of the first and/or second communication device as attestation information, from the first and/or second communications devices to the second and/or first communication device, eavesdropping on the attestation data structure by means of a monitoring device arranged within a data transmission path of the communication connection, examining the attestation information in a comparison to a specified guideline, and a corresponding communication system, a communication device, a monitoring device and a computer program product for carrying out the method.

### CROSS-REFERENCE TO RELATED APPLICATIONS

This application claims priority to PCT Application No. PCT/EP2018/065020, having a filing date of Jun. 7, 2018, based on DE 10 2017 212 474.1, having a filing date of Jul. 20, 2017, the entire contents of both are hereby incorporated by reference.

### FIELD OF THE TECHNOLOGY

The following relates to a method, a communication system, a communication device and a monitoring device for examining connection parameters of a cryptographically protected communication connection between a first communication device and a second communication device during the establishment of the cryptographically protected communication connection.

### BACKGROUND

Cryptographically protected communication protocols, such as an IP security protocol IPsec/IKE or the transport layer security protocol TLS, DTLS QUIC, protect data to be transmitted against manipulation and spying. The process involves an authentication of the communication partners and an agreement of a session key. When a connection is established via the TLS protocol, a first communication device referred to as a TLS client initiates a connection to a second communication device, which is referred to as a TLS server. The TLS server is typically authenticated against the TLS client with a certificate. The TLS client examines the trustworthiness of the certificate and checks whether the name of the TLS server, i.e. its DNS name, matches the name specified in the certificate. Optionally, the TLS client can authenticate itself against the TLS server with its own certificate. Thereupon either the TLS client sends the TLS server a secret random number encrypted with the public key of the TLS server, or the two parties calculate a shared secret with a Diffie-Hellman key exchange. From the secret a cryptographic key is then derived which is used for the encryption of the payload messages of the connection. The TLS protocol is implemented in a session layer (layer 5) of the OSI reference model for network protocols, i.e. above the TCP or UDP protocol.

The cryptographically protected Internet Protocol Security IPsec protocol enables a secure communication over potentially insecure internet protocol (IP) networks, such as the internet. In particular, the Internet Key Exchange protocol IKE, in version 2, is used for key management. The IPsec protocol works directly on the internet layer, which corresponds to the network layer (layer 3) of the OSI reference model.

In particular in industrial environments, such as in automation systems, there is a requirement to monitor the communication between the individual devices.

Known approaches aim to be able to monitor the user data transmitted. This conflicts, however, with end-to-end protection of transmitted data. There is a need to allow some monitoring of cryptographic connections without jeopardizing the protection of the end-to-end transmission.

Patent EP 3 171 570 A1 discloses a device which enables options supported by a terminal of a cryptographically protected communication protocol to be examined. For this purpose a communication unit actively initiates a communication connection to the terminal or the communication unit receives an initiation message from the terminal and sets up a test communication. In this case, the configuration of the communication protocol can be examined on the terminal. Such an additional establishment of a test communication creates, on the one hand, additional load on a communication network as well as on the terminal to be examined. In addition, the data that can be tested are limited exclusively to information transmitted by the terminal in the authentication and key agreement in accordance with the security protocol.

### SUMMARY

Against this background, an aspect relates to monitor an extended number of connection parameters while loading the communication partners and the communication network as little as possible and not putting the protection of the end-to-end transmission at risk.

According to a first aspect embodiments relate to a method for examining connection parameters during establishment of a cryptographically protected communication connection between a first communication device and a second communication device, comprising the method steps:

transmitting (11) an attestation data structure, which contains at least one connection parameter of the first and/or second communication device as attestation information, from the first and/or second communications devices to the second and/or first communication device,

eavesdropping on the attestation data structure by means of a monitoring device arranged within the data transmission link of the communication connection, and

examining the attestation information against a specified policy.

This allows a third party to monitor whether the security protocol is being used as expected. This can be carried out while establishing a communication connection between the actual communication partners, so that no additional test communication to an additional communication unit needs to be built. Nor does any active component need to be introduced into the communication path which could affect the protected communication connection or may have an effect on the response times of the communication partner. This means that an end-to-end security of the communication connection is not weakened. There is also no additional communication connection established which loads the communication device or the communication network. Only one item of information examinable by third parties is provided for the established cryptographically secured communication connection. This is advantageous, in particular, in the case of security-critical industrial control systems in order to ensure that a cryptographically protected control communication only takes place as planned and approved. In particular, it means that in ongoing operation it is possible to verify that an accepted and approved system configuration is only being used as approved in actual operation. This monitoring of the integrity or the compliance with the specified security policy is possible even though the data transfer is cryptographically protected.

In an advantageous embodiment the cryptographically protected communication connection is established according to a transport layer security protocol TLS/DTLS/SSL or an Internet Protocol security protocol IPsec, and the attestation data structure is formed as an extension of a protocol message, in particular a TLS handshake message or an internet key exchange IKE message.

This has the advantage that only one or multiple messages are supplemented with the attestation data structure, but the sequence of the security protocol used remains unchanged. Such extensions are simple to implement and are supported by the standards of the given security protocols. In order to enable passive reading of the message, the attestation data structure is transmitted in the readable, non-encrypted part of the protocol messages of the security protocol. For this purpose, in the case of TLS, handshake messages in particular can be used for the authentication and key agreement.

In an advantageous embodiment an attestation data structure with at least one connection parameter of the transmitting communication device is sent both from the first communication device and from the second communication device to the respective other communication device as attestation information.

This allows not only the connection parameters of the first communication connection, which initiates the establishment of the connection and is usually designated as a client, to be examined, but also connection parameters of the second communication device, which is commonly designated as a server.

In an advantageous embodiment, the attestation data structure is cryptographically protected by an attestation key.

This enables the integrity of the attestation data structure and also the authenticity of the sending communication device to be monitored. The cryptographically protected attestation data structure can be protected, in particular, by a cryptographic checksum, in particular a digital signature or by means of a cryptographic message authentication code (MAC). It is also possible that the cryptographically protected attestation data structure or individual fields of the cryptographically protected attestation data structure are encrypted. The cryptographic checksum is part of the attestation data structure, i.e., that the attestation data structure consists of an attestation information item and a cryptographic attestation checksum. However, it is also possible that the cryptographic attestation checksum exists separately from the attestation information.

For example, the key of the transmitting communication device used for the authentication can be used as the attestation key.

This has the advantage that no additional key material needs to be generated. During an authentication of the communication devices in a TLS or IPsec protocol, the public keys of the communication partners are usually transferred unencrypted as certificates and in the same way as the attestation data structure, can therefore be extracted, verified and used for the further cryptographic securing of the attestation data structure.

In the following, “extracting” refers in particular to the provision of a data structure to a third component outside the communication connection itself. The extracted information is a copy of the data structure received by a communication device. The original data structure is output to the receiving communication device via the communication connection.

In an advantageous embodiment, the attestation key is provided to an evaluation device via a different, separate connection from the communication connection.

This has the advantage that the evaluation of the attestation data structure can only be carried out by such devices as have received the attestation key. Therefore explicitly specified evaluation devices can be authorized for the evaluation of a communication device. The attestation key can be any cryptographic key. The connection monitored with the method according to embodiments are designated as the communication connection. A separate connection, different from this, can be a connection routed over a different data transmission path. The separate connection can also use the same data transmission path as the monitored communication connection however, while nevertheless being a dedicated, logically separate connection.

In an advantageous embodiment the attestation information is provided by the transmitting communication device of a storage device, in particular a database or a logging server.

This has the advantage that the evaluation of the attestation information can be carried out, for example, in a temporally decoupled and centralized manner.

In an advantageous embodiment the attestation data structure comprises only one reference value and the attestation information on the storage device is ascertained via the reference value.

This has the advantage that a minimal additional load is applied to the communication connection. On the other hand, the sending communication device can store the attestation information via a different connection, for example an already existing and/or secure connection, on a storage device such as the above-mentioned database or a logging server. The reference value may be, in particular, a cryptographic hash value of the attestation information.

In an advantageous embodiment predefined measures are carried out, in particular issuing a warning signal and/or blocking the communication connection, if a deviation from the policy is determined during the examination.

According to a second aspect embodiments relate to a communication system for examining connection parameters during the establishment of a cryptographically protected communication connection between a first communication device and a second communication device, wherein at least the first and/or second communication device is designed so as to transmit an attestation data structure to the second and/or first communication device, and the attestation data structure contains at least one connection parameter of the first and/or second communication device as attestation information, comprising:

a monitoring unit, which is arranged within a data transmission path of the communication connection and designed so as to extract the attestation data structure and

an examination unit which is designed so as to examine the attestation information against a specified policy.

A data transmission path is a physical connection link between the first and second communication device, consisting of one or more physical data transmission links. The physical data transmission path of a logical communication connection can comprise a plurality of data transmission links and transmission components, such as routers, switches, or firewalls. For example, a monitoring device taps off the data within a transmission component or else the protocol messages at an output of a transmission component, and extracts the attestation data structure from these. The communication system allows security-related information of the communication devices and the communication connection to be made accessible to third parties.

According to a third aspect, embodiments relate to a communication device for examining connection parameters during the establishment of a cryptographically protected communication connection between the communication device and a second communication device, comprising a transmission device which is designed so as to transmit a cryptographically protected attestation data structure which contains at least one connection parameter to the second communication device as attestation information.

The communication device therefore allows connection parameters that are used for the currently established communication connection to be provided on the communication connection itself, so that these can be read out for monitoring purposes.

In one advantageous embodiment the communications device is implemented as a client device or as a server device.

This enables attestation information on connection parameters used by both end components of the communication connection to be eavesdropped on.

According to a fourth aspect, embodiments relate to a monitoring device for examining connection parameters during the establishment of a cryptographically protected communication connection between a first communication device and a second communication device, comprising a monitoring unit which can be arranged within the data transmission path of the communication connection and is designed to eavesdrop on the attestation data structure and to provide the attestation information to an examination device, and an examination unit which is designed to examine the attestation information against a specified policy.

Eavesdropping refers to a passive process in which the data are copied and this copy is output to the examination unit. The original data are output unchanged to the communication partner. The eavesdropping does not change or add to the original data. The eavesdropping causes no or only a short delay time. Thus, attestation information can be extracted without significant influence on the original communication connection.

In an advantageous embodiment the monitoring device additionally comprises an enforcement unit which is designed to carry out predefined measures, in particular to output a signal and/or block the communication connection, if a deviation from the policy is determined during the examination.

According to a fifth aspect the solution relates to a computer program product (non-transitory computer readable storage medium having instructions, which when executed by a processor, perform actions) that can be loaded directly into a memory of a digital computer and comprises program code parts which are suitable for carrying out the steps of the method described above.

### BRIEF DESCRIPTION

Some of the embodiments will be described in detail, with reference to the following figures, wherein like designations denote like members, wherein:

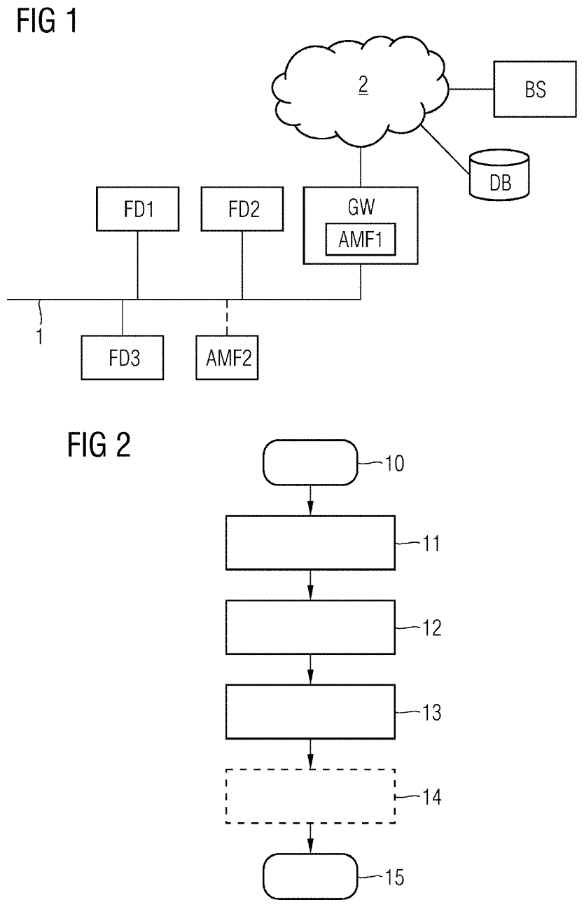

FIG. 1 depicts an exemplary embodiment of a communication system in a schematic representation;

FIG. 2 depicts an exemplary embodiment of the method as a flow diagram.

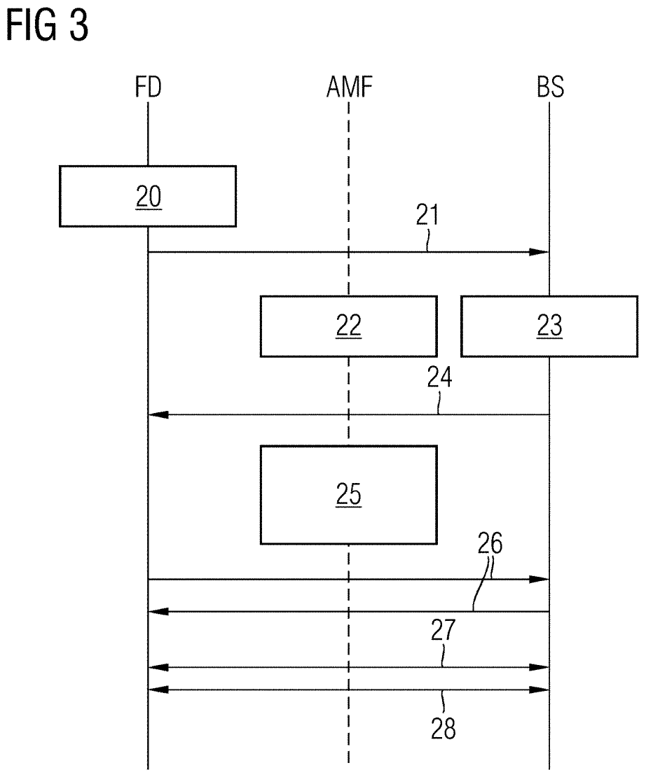

FIG. 3 depicts an exemplary embodiment of the method integrated into a TLS handshake, as a process diagram;

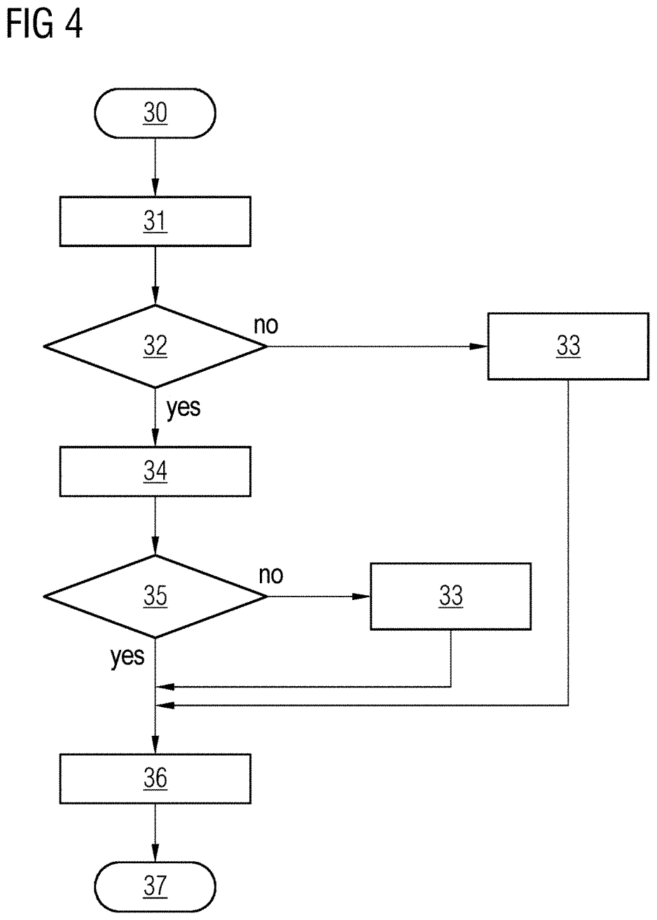

FIG. 4 depicts an exemplary embodiment of the method implemented in a monitoring device as a flow diagram;

FIG. 5 depicts a first exemplary embodiment of a monitoring device in a schematic representation; and

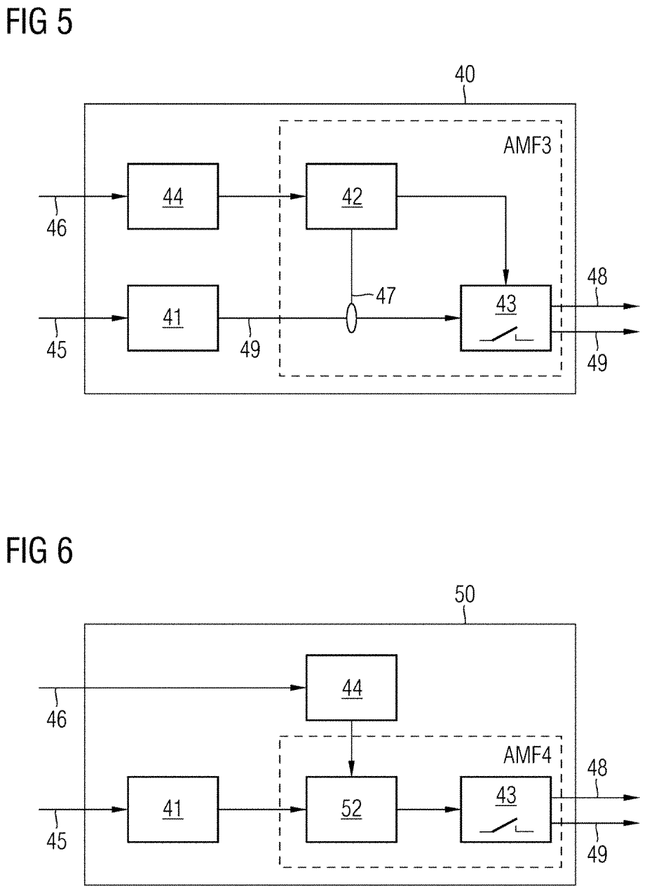

FIG. 6 depicts a second exemplary embodiment of a monitoring device in a schematic representation.

### DETAILED DESCRIPTION

Equivalent parts are provided with the same reference symbols in all figures.

FIG. 1 shows an example of a communication system according to the embodiment of the invention, which is implemented, for example, as an automation network with a plurality of field devices as communication devices FD1, FD2, FD3. The communication devices FD1, FD2, FD3 are connected via a gateway GW and a public network 2 to a backend server BS, such as an industrial Internet of Things backend system. The communication devices FD1, FD2, FD3 transmit, in particular, diagnostic data to the backend server BS via a gateway GW. In establishing a cryptographically protected communication structure by means of a TLS protocol, in addition to the information which is usually exchanged the first communication device FD1 as a TLS client sends an attestation data structure with at least one connection parameter as attestation information to the backend server as a second communication device. Optionally, the second communication device as a TLS server can also send its connection parameters in an attestation data structure to the first communication device. The attestation data structure is used, for example, as an extension of a message of the TLS protocol used, or sent via the gateway as a stand-alone message to the backend server BS as a TLS server. The gateway GW contains an integrated monitoring device AMF1, which reads out and evaluates the attestation data structure.

This allows the gateway GW, as a component that is not involved in the actual connection structure of the protected communication connection, for example, to reliably examine which application program has initiated or terminated the cryptographically protected communication connection on which communication device. This means that the gateway GW in particular can verify whether the communication connection is established by an approved application on a permissible field device with a current firmware version, and whether the contacted backend service is actually the specified service.

During the establishment of a cryptographically protected communication connection between a field device FD1 and a field device FD2, in the same way, by the first communication partner FD1 which initiates the communication connection, connection parameters are encoded into an attestation data structure as attestation information and transmitted to the second communication partner FD2. A monitoring device AMF2, which is arranged within the data transmission path of the communication connection, can eavesdrop on this attestation data structure from the data transmission path and examine it.

In a variant, the first communications device and/or the second communication device FD1, FD2, FD3, BS only send a reference value of the attestation information. The first communication device FD1 transmits the attestation information to a storage device DB, for example via a second protected connection. The attestation information is stored there, identified with the same reference value. The reference value can be, for example, a hash value of the attestation information. However, an address information, for example a Uniform Resource Locator URL, can also be used as a reference value, via which the attestation information can be determined. The examination unit AMF1, AMF2 can determine and evaluate the actual attestation information in the storage device DB on the basis of the reference value.

The attestation information can be provided to a logging server which logs some or even all transmitted messages. Similarly, the attestation information can be provided to an intrusion detection system or an artificial intelligence analysis unit.

In FIG. 2 the method of the embodiment will now be described on the basis of a flow diagram. In the initial state 10, a first communication device would like to establish a cryptographically protected communication connection to a second communication device, at FD2, via a cryptographic authentication and key agreement protocol. Such an authentication and key agreement protocol is, for example, a transport layer security protocol TLS, or else its predecessor version which is denoted by secure socket layer protocol SSL, an Internet Protocol Security Protocol IPsec with the Internet Key Exchange protocol IKEv2, or other appropriate protocols.

In the first method step 11 a first communication device sends an attestation data structure, which contains at least one connection parameter of the transmitting communication device, to the second communication device as attestation information. The first communication device, which initiates the establishment of the cryptographically protected communication, is usually referred to as a client, and the second communication device, which receives the request for a secure communication connection, is usually referred to as a server. Optionally, the second communication device also determines the connection parameters used in the second communication device and sends these to the first communication device as an attestation data structure.

The attestation data structure transmitted to the other respective communication partner via the data transmission path is then extracted in the method step 12 by a monitoring device, such as AMF1 or AMF2 in FIG. 1. A communication connection which is established logically between the first communication device and the second communication device is physically transmitted via a data transmission path composed of a plurality of partial transmission links. A data transmission link is terminated by a transfer component, such as a router or switch, for example. This performs routing functions or other actions, but the actual cryptographically protected communication connection remains unaffected.

A monitoring device can be implemented, for example, as part of such a transmission component, or introduced into the transmission link between two transmission components. In eavesdropping on the attestation data structure the received data or messages are copied and the copy is extracted for further evaluation. The received data or messages themselves are forwarded unchanged via the transmission link.

The attestation information is then examined against a specified policy. See method step 13. Optionally, in an additional method step 14 predefined measures can be carried out if a deviation from the policy is determined during the examination.

Connection parameters which are included in an attestation information item according to the embodiment of the invention are, for example, a public key being used of the first communication device or its certificate used, a public key being used of the second communications device or its certificate. The first and second communication device can be used as a connection parameter to communicate whether, and if so which, operations have been used for certificate validation, e.g. whether or not a certificate path validation or a validation using a positive certificate list (Certificate White List) has taken place. A communication device can be used as a connection parameter to communicate whether and with which method it has checked a certificate revocation. In addition, for example, the agreed version of the security protocol and/or the negotiated encryption functions, the so-called cipher suite, can be included.

Furthermore, allowed options of the security protocols can be specified such as the use of a session resumption function in the case of a TLS protocol. As connection parameters, a hash/signature algorithm combination used for a TLS handshake operation, the IP address and port of the TLS client or the IP address and port of the TLS server, the time that the connection is established, applications which the TLS connection sets up, can be specified, for example by the identifier and version code. This applies to both the client and the server. In addition, the TLS library used can also be specified as a connection parameter, for example by means of an appropriate ID and the version specification for the client and the server. A connection parameter can be an additional attestation of a local system status, for example, a TPM quota, for confirming the current platform configuration for the client and for the server. It can also be a trusted platform module, also known as a TPM, which issues an attestation via the current content of a platform configuration register.

Furthermore, in addition to applications a communication device can also itself confirm such parameters as its version or its publisher, for example. This is of particular advantage if the communication device is a gateway for the exchange of industry data, such as an industrial data space gateway. In this case data are transferred between two gateways for the exchange of industrial data wherein, for example, a firewall at the boundary of a company network can collect and test the attestation data structure. In doing so it is possible to monitor which applications, also known as apps or services, are using a data transmission path. Furthermore, it is possible that the attestation data structure comprises identification information of the data to be transferred. This has the advantage that it is possible to monitor which data are transferred via the data transmission path. Furthermore, it is possible to collect and store information about the exchanged data in a revision-secure manner, i.e. information required to be retained or worthy of being retained.

The attestation data structure is cryptographically protected by an attestation key of the particular sending communication device. The attestation key can be, for example, the public key of the first or the second communication device, which are mutually transferred during the establishment of the cryptographically protected connection. In one variant, however, a separate attestation key for a particular connection or specifically for a communication device can also be used for cryptographically securing the attestation data structure. In this case, this attestation key must be communicated to the monitoring device outside of the communication connection.

An example sequence of the method will now be explained based on the example of a communication connection between a field device FD as the first communication device and a backend server BS as the second communication device in an automation network, as shown in FIG. 1.

The logical communication connection between the first and second communication device FD, BS is routed via a physical data transmission path of the automation network 1 to the gateway GW and from there onwards via, for example, a public network 2 to the second communication device BS. In the gateway GW an eavesdropping and examination unit, for example, is combined in a monitoring device AMF. The communication connection is then established, for example, in accordance with the transport layer security TLS protocol. For this purpose, in a so-called TLS handshake the communication devices are mutually authenticated and a session key for the cryptographic protection of the subsequent data transfer is negotiated. This TLS handshake is then extended as follows.

The first communication device FD generates attestation information in block 20 and encodes this as an extension to an existing TLS message, for example, in a client hello message 21. To this end the first communication device FD or even the second communication device BS can support the following extension in the server hello:

struct {

| | |
|---|---|
| senderPK | byte_string; |

| | |
|---|---|
| receiverPK | byte_string; |
| TLSversion | string; |
| cipherSuite | string; |

| | |
|---|---|
| senderIP | byte_string; |

| | |
|---|---|
| receiverIP | byte_string; |
| sigAlg | string; |
| policy | string; |

} SessionAttestation;

This attestation structure comprises as connection parameters the public key of the sender and the receiver, the TLS version, the cipher suite used, the IP addresses of the sender and the receiver, the signature algorithm used and additional policy, i.e. policy information such as the date of the last examination of the revoked certificates, TLS libraries used, time of establishing the connection, or else information about the application or the application program that initiated the establishment of the TLS connection.

Alternatively, the authentication data structure can be integrated in the TLS handshake as an additional message. In this case the attestation information, which is referred to in the encoding as “Session Attestation”, is sent as part of a newly defined message type, for example “session attestation”. The structure of the encoded attestation information as SessionAttestation can then correspond to the above data structure.

In the following, an extension of the message types of the handshake protocol to include the message type “session attestation” is presented. The extension corresponds to the type 21 and is shown below in bold, the original definition of the message types corresponds to the TLS standard in accordance with IETF RFC 4246, Section 7.4.

enum {

hello_request(0), client_hello(1), server_hello(2), certificate(11),
server_key_exchange(12),
certificate_request(13), server_hello_done(14),
certificate_verify(15), client_key_exchange(16),
finished(20), session_attestation(21), (255)

} HandshakeType;
struct {

HandshakeType msg_type; /* handshake type */
uint24 length; /* bytes in message */
select (HandshakeType) {

case hello_request: HelloRequest;
case client_hello: ClientHello;
case server_hello: ServerHello;
case certificate: Certificate;
case server_key_exchange: ServerKeyExchange;
case certificate_request: CertificateRequest;
case server_hello_done: ServerHelloDone;
case certificate_verify: CertificateVerify;
case client_key_exchange: ClientKeyExchange;
case finished: Finished;
case session_{—}attestation: SessionAttestation;

} body;

} Handshake;

The monitoring device AMF then reads either the TLS message as a whole or the attestation data structure alone from the client hello message 21 and checks this, see block 22. The second communication device BS also generates attestation information, see block 23, with connection parameters which the second communication device uses, or security mechanisms in accordance with the information generated for the first communication device, and sends this in a server hello message 24 to the first communications device FD. The attestation information is read and verified by the monitoring device AMF, see block 25. Later in the TLS handshake sequence the public key of the second communication device is then sent to the first communication device, and correspondingly the public key of the first communication device FD can be sent to the second communication device BS.

After the exchange, both communication devices confirm with a ChangeCipherSpec that the following messages are protected using the negotiated security parameters, see message 26.

At the end of the handshake the first communication device FD generates a checksum, for example by means of a hash function over all previously exchanged messages. This checksum is incorporated into a key derivation for the actual session key. The second communication device BS performs the same calculation. Thereafter, both communication devices, FD and BS, exchange a final message of the handshake with a Finish message 27. This message is encrypted, so that both communication devices prove by application of the locally derived session key that they are in possession of the correct key and, by implication, that all of the messages in the handshake were identical on both sides. Subsequently, data are cryptographically protected using the negotiated key, see 28.

The monitoring device AMF examines the attestation information against a specified policy, and if the attestation information differs from the policy an alarm signal is generated and/or establishment of subsequent connections is blocked.

The examination of the attestation data structure in the monitoring device AMF is described in FIG. 4 based on a process diagram. The sequence begins with the start state 30, in which the monitoring device extracts or eavesdrops on connection establishment messages, such as the aforementioned TLS messages. The eavesdropping comprises duplication of the received messages and outputting the copy of the messages to an evaluation unit, and forwarding the original messages to the data transmission path to the receiving communication device. This is carried out in an eavesdropping unit of the monitoring device.

Then, in an examination unit the attestation information is examined against a security policy, see 32. If the attestation information does not correspond to the security policy, an error signal is provided, see 33. If the attestation information does correspond to the security policy, then optionally, in the next step 34, the message of the second communication device is extracted to the first communication device and eavesdropped and also examined against the security rule in step 35. If the attestation information does not match the security policy, an error signal 33 is issued. The attestation information checked as being valid is forwarded to an enforcement unit. In the enforcement unit valid attestation information items are evaluated and/or stored, for example, see 36. Error signals are implemented according to predefined measures. For example, error signals are provided to an assigned unit or else the communications connection is blocked and aborted, for example. At this stage the final state 37 is reached.

A network component which integrates functions of a monitoring device is shown in FIG. 5 and FIG. 6. The network component 40, for example a router, switch or access point of a communication network, receives data 45 of a communication connection, for example in a routing function 41. The routing function 41 contains routing tables by way of which an output port to the next data transmission link 49 is determined, and outputs the data accordingly onto a data transmission link 49. The monitoring device AMF taps the connection establishment messages using an eavesdropping unit 47. The eavesdropping unit 47 can be implemented, for example, as a mirroring port of a network switch or as a one-way communication component such as a data diode. The monitored, for example mirrored, messages are then forwarded to the examination unit 42. It is here that the attestation information is examined against a security policy. The security policies are provided, for example, from a policy database 44 of the examination unit 42. Security policies in this case can be provided or updated via a connection 46 from a policy database.

The examination unit 42 analyzes the messages of the TLS handshake, which is executed in plain text, for the presence of an attestation data structure in the client Hello message and/or the server Hello message. The verification unit 42 provides the evaluation result to an enforcement unit 43. In the case of a positive test result this accordingly outputs the data to the data transmission link 49 unchanged. If the policy is violated, for example, an error message 48 is output by the enforcement unit 43. Optionally, in case of a breach of the policy the data output can additionally be blocked. The blocking or locking can be carried out, for example, by interrupting the network connectivity by adapting a network filter policy, that is to say, the corresponding IP address or port number that are used for establishing the impermissible communication connection are locked. But a disconnection message can also be sent to the communication partner.

The monitoring device AMF 3 thus consists of an eavesdropping unit 47, an examination unit 42 and an enforcement unit 43. In the component 40 these have an integrated design.

The monitoring device AMF 4 in FIG. 6 comprises a combined eavesdropping and examination unit 52, which in turn is integrated in a network component 50. The combined eavesdropping and examination unit 52 in this case is implemented directly in the data transmission link. The eavesdropping and examination unit 52 performs the same functions as the units 42 and 47 in the network component 40. For the enforcement of the measures resulting from the examination the monitoring device AMF 4 comprises the enforcement unit 43 with the functions as described in FIG. 5 for the monitoring device AMF 3.

All features described and/or drawn can be advantageously combined with each other within the scope of the embodiment of the invention. The embodiment is not limited to the described exemplary embodiments, and in particular to the above-mentioned authentication and key negotiation protocols.

Although the present invention has been disclosed in the form of preferred embodiments and variations thereon, it will be understood that numerous modifications and variations could be made thereto without departing from the scope of the invention.

For the sake of clarity, it is understood that the use of “a” or “an” throughout this application does not exclude a plurality, and “comprising” does not exclude other steps or elments.

1. A method for examining connection parameters during establishment of a cryptographically protected communication connection between a first communication device and a second communication device, the method comprising:
transmitting an attestation data structure, which contains at least one connection parameter of the first communication device and/or the second communication device as attestation information, from the first communication device and/or the second communications devices to the second communication device and/or the first communication device;
eavesdropping on the attestation data structure by means of a monitoring device arranged within a data transmission path of the cryptographically protected communication connection; and
examining the attestation information in comparison to a specified policy.

2. The method in claim 1, wherein the cryptographically protected communication connection is established according to a transport layer security protocol (TLS/DTLS/SSL) or an Internet Protocol security protocol (IPsec) and the attestation data structure is formed as an additional protocol message, an extension of a protocol message a TLS handshake message or an internet key exchange IKE message.

3. The method claim 1, wherein the attestation data structure with at least one connection parameter of the transmitting communication device is sent both from the first communication device and from the second communication device to the respective other communication device as attestation information.

4. The method in claim 1, wherein the attestation data structure is cryptographically protected by an attestation key.

5. The method in claim 4, wherein the attestation key is a key used for authentication of the transmitting communication device.

6. The method as claimed in claim 4, wherein the attestation key is provided to an evaluation device via a different connection than the cryptographically protected communication connection.

7. The method in claim 1, wherein the attestation information is provided by the transmitting communication device of a storage device, the storage device being a database or a logging server.

8. The method in claim 7, wherein the attestation data structure comprises only one reference value and the attestation information on the storage device is ascertained via the one reference value.

9. The method in claim 1, wherein issuing a warning signal and/or blocking the communication connection are carried out if a deviation from the specified policy is determined during the examining.

10. A communication system for examining connection parameters during an establishment of a cryptographically protected communication connection between a first communication device and a second communication device, wherein at least the first communication device and/or the second communication device is/are designed in such a way as to send an attestation data structure to the second communication device and/or the first communication device and the attestation data structure contains at least one connection parameter of the first communication device and/or the second communication device as attestation information, comprising:
an eavesdropping unit, which is arranged within a data transmission path of the cryptographically protected communication connection and designed so as to extract the attestation data structure; and
an examination unit which is designed so as to examine the attestation information against a specified policy.

11. A communication device for examining connection parameters during an establishment of a cryptographically protected communication connection between the communication device and a second communication device, comprising:
a transmission unit which is designed to send a cryptographically protected attestation data structure, which contains at least one connection parameter as attestation information, to the second communication device.

12. The communication device in claim 11, wherein the communication device is designed as a client device and/or as a server device and is designed to carry out a method for examining connection parameters during establishment of the cryptographically protected communication connection between the first communication device and the second communication device.

13. A monitoring device for examining connection parameters of a cryptographically protected communication connection between a first communication device and a second communication device, comprising:
an eavesdropping unit which is arranged within a data transmission path of the cryptographically protected communication connection and is designed to extract an attestation data structure and to provide the attestation information to an examination unit;
wherein the examination unit is designed so as to examine the attestation information against a specified policy.

14. The monitoring device as claimed in claim 13, further comprising an enforcement unit, which is designed to block the cryptographically protected communication connection, if a deviation from the specified policy is determined during the examining.

15. A computer program product, comprising a computer readable hardware storage device having computer readable program code stored therein, said program code executable by a processor of a computer system to implement a method as claimed in claim 1.
